(19) United States
(12) Patent Application Publication
(10) Pub. No.: US 2010/0226449 A1
(43) Pub. Date: Sep. 9, 2010

(54) Method and System for Reducing the Peak-to-Average Power Ratio

(75) Inventors: Jacek Ilow, Halifax (CA); Craig Jamieson, Edmonton (CA)

Correspondence Address: Jonathan P. O''Brien, Ph.D.;Honigman Miller Schwartz and Cohn, 350 East Michigan Avenue, Suite 300, KALAMAZOO, MI, 49007, US

(73) Assignee: Dalhousie University, Halifax (CA)

(21) Appl. No.: 12/666,103

(22) PCT Filed: Jun. 27, 2008
(86) PCT No.: PCT/CA08/01209

§ 371 Date: May 20, 2010

Related U.S. Application Data
(60) Provisional application No. 60/937,783, filed on Jun. 29, 2007.

(51) Int. Cl. H04L 27/28; H04B 1/10

(52) U.S. Cl. 375/260; 375/346

(57) ABSTRACT

This invention provides a method and system for reducing the PAPR. The method involves (i) intentionally inserting error(s) into the time or frequency domain and (ii) employing various bit mapping schemes to provide a significant reduction in the PAPR. An embodiment of the error insertion of the method involves intentionally inserting symbol error(s) into the quadrature amplitude modulation (QAM) symbol stream before applying discrete Fourier transform in OFDM. The method trades off the coding gain of the system for the PAPR reduction of the OFDM signals and does not require transmission of side information. It further has reduced complexity and improved bit error rate (BER) performance when used with a typical non-linear amplifier as compared to alternative existing methods (Gray coding, tone injection, tone reservation, etc.)

### CROSS REFERENCE

This application claims priority to U.S. provisional application No. 60/937,783 filed on Jun. 29, 2007, the entire contents of which are incorporated herein.

### BACKGROUND OF THE INVENTION

The efficient transmission of information in modern communication systems requires well designed methods to ensure high bandwidth usage particularly when operating in harsh, multipath conditions. Orthogonal frequency division multiplexing (OFDM), the de facto standard modulation scheme employed, splits the data stream into sub-carriers that span the communication frequency range. As more carriers are added the peak-to-average power ratio (PAPR) increases beyond the linear range of receiver amplifiers. To combat this many methods of reducing the PAPR have been proposed.

### SUMMARY OF INVENTION

This invention provides a method and system for reducing the PAPR. The method involves (i) intentionally inserting error(s) into the time or frequency domain and (ii) employing various bit mapping schemes to provide a significant reduction in the PAPR. An embodiment of the error insertion of the method involves intentionally inserting symbol error(s) into the quadrature amplitude modulation (QAM) symbol stream before applying discrete Fourier transform in OFDM. The method trades off the coding gain of the system for the PAPR reduction of the OFDM signals and does not require transmission of side information. It further has reduced complexity and improved bit error rate (BER) performance when used with a typical non-linear amplifier as compared to alternative existing methods (Gray coding, tone injection, tone reservation, etc.)

In one aspect, the invention features a method of reducing the (PAPR) in a multi-carrier system, by iteratively introducing errors into the signal; calculating the PAPR for each iteration; and determining the error that results in the largest reduction of the PAPR. Each error introduced into the signal (for example, symbol stream) at the transmitter is chosen so that it is correctable by the error correction capabilities of the receiver. In another aspect, the invention features a communication system, such as an OFDM communication system which includes a receiver and transmitter configured to iteratively introduce errors into an OFDM signal, calculate the PAPR for each iteration, and determine the error that results in the largest reduction of the PAPR, in which each error introduced into the signal is chosen so that each error is correctable by the error correction capabilities of the receiver. Embodiments of these aspects include one or more of the following. The multi-carrier system is an orthogonal frequency division multiplexing system. The iterations are conducted until the PAPR is minimized. The iterations are conducted until the PAPR is reduced to a user defined predetermined value. The error is introduced in the transmitter. The error is corrected in the receiver. The receiver uses an error correction code, such as forward error correction (FEC). The method and system utilize a non-Gray coding bit mapping scheme. The non-Gray coding bit mapping scheme is radially symmetric. The errors are introduced in the time domain. The errors are introduced in the frequency domain. The errors are introduced in the frequency domain at the QAM symbol level. The errors are 1 bit errors. The errors are 1 bit errors for one symbol changed in the original symbol stream. The step of iteratively introducing error comprises introducing error in one of the N sub-carriers initially (in the first pass) and then one error on one of the N−1 sub-carriers in the second pass. Multiple passes are allowed depending on what the error correction capability loss is allocated for PAPR reduction. The step of iteratively introducing error comprises introducing error in a subset of the sub-carriers. The step of iteratively introducing error comprises introducing error in N/2 sub-carriers. The step of iteratively introducing error comprises limiting the maximum number of errors allowed. The step of iteratively introducing error comprises limiting the maximum number of errors allowed based on the average improvement in the PAPR determined by the relationship (PAPR(n)−PAPR(m))/PAPR(n), where n and m represent different passes of the PAPR reduction scheme.

Other advantages and features of the invention will become more apparent from the detailed description provided.

### BRIEF DESCRIPTION OF THE DRAWINGS

FIG. 1 Communication system with frequency domain perturbations (error insertion).

FIG. 2 Communication system with time domain perturbations (error insertion).

FIG. 3 An example of the method of this invention implemented for a simple Gray mapping scheme. The initial pass of the algorithm is shown in this figure.

FIG. 4 An example of the method of this invention implemented for a simple Gray mapping scheme. The subsequent pass of the algorithm is shown in this figure.

FIG. 5 Flowchart for the general implementation for the method of this invention.

FIG. 6 Bit mapping constellations for a 16-ary scheme using (a) traditional Gray mapping and (b) a symmetric bit mapping.

FIG. 7 Bit mapping constellations for (a) a circular (8, 8) configuration and (b) a hexagonal lattice.

FIG. 8 The CCDF of the PAPR for iterations that only change subsets of the sub-carriers in a 16 sub-carrier system.

FIG. 9 The frequency of symbols changed for each pass ranked by their amplitude (distance from the center) for a 16-ary constellation.

FIG. 10 The CCDF of the PAPR after 1, 2, and 3 passes for a 16 sub-carrier system.

FIG. 11 The CCDF of the PAPR after 1-9 passes for a 64 sub-carrier system.

FIG. 12 The CCDF of the PAPR for various PAPR reduction schemes in a 16 sub-carrier system.

FIG. 13 The CCDF of the PAPR for various PAPR reduction schemes in a 64 sub-carrier system.

### DETAILED DESCRIPTION OF THE INVENTION

The method involves intentionally inserting error(s) into the time or frequency domain, for example symbol errors inserted before deploying an inverse discrete Fourier transform (IDFT), and employing various bit mapping schemes to provide a significant reduction in the PAPR of the transmitted signal.

High PAPR in a data stream with many sub-carriers comes from the constructive interference of the modulation symbols used to encode the data. To reduce the PAPR one or more symbol is changed introducing errors into the data stream. These errors are corrected in the receiver using its existing error correction capabilities. To find the optimal errors to insert each symbol is considered in turn, replaced by another symbol (thus introducing an error), and the PAPR is recalculated at each iteration. If the PAPR is reduced, this error could be included in the data stream or other symbols can be inserted and the PAPR recalculated and compared to the previous PAPR values. In some embodiments, this iterative procedure is repeated until a maximum amount of error providing the maximal reduction in PAPR has been achieved. In other embodiments, the iterative procedure is continued until a user defined predetermined reduction of PAPR occurs.

A given error correction code will be capable of correcting certain types of errors and a certain number of them. Due to the noisy environment some of the error correction must be used to correct natural transmission errors. One advantage of the invention is to leverage the error correction capabilities to utilize the error(s) intentionally introduced at the transmitter to reduce the PAPR. Another advantage of the method in this invention is the ability to trade off error correction used for PAPR reduction with that used for natural errors. The balance between the number of errors allowed for natural errors and those employed in PAPR reduction will be application specific.

The standard bit mapping scheme, Gray coding, was developed in part to reduce the effects of natural symbol errors occurring in signal transmission. A bit mapping scheme with larger Euclidean distance between symbols with correctable errors leads to a reduced PAPR due to less constructive interference in the signal caused by repeated symbols in the data stream. A compromise between these two bit mapping design goals is to increase the Euclidean distance between symbols by using radial symmetry. Symbol constellations of various sizes and geometries have been designed and are known in the art. Although these constellations slightly increase the bit error rate (BER) of the system in the presence of natural noise, their use in this method leads to significant reduction in the PAPR, which reduces in the system BER significantly in the presence of a non-linear amplifier.

In some embodiments, the method utilizes non-standard constellations, i.e., other than Gray Coding, to allow for reduced complexity in the method. The complexity of the method can be reduced by limiting the sets of errors searched by using the symmetry of the constellations. Further reduction in complexity can be obtained by tuning the range of allowed symbol changes as a function of the iteration step, starting from the outer ring of symbols in the symmetric bit mapping and working inward on subsequent iterations. The implementation, the number of iterations and the rings to consider for symbol changes, will be application dependent and can be determined by Monte Carlo simulations.

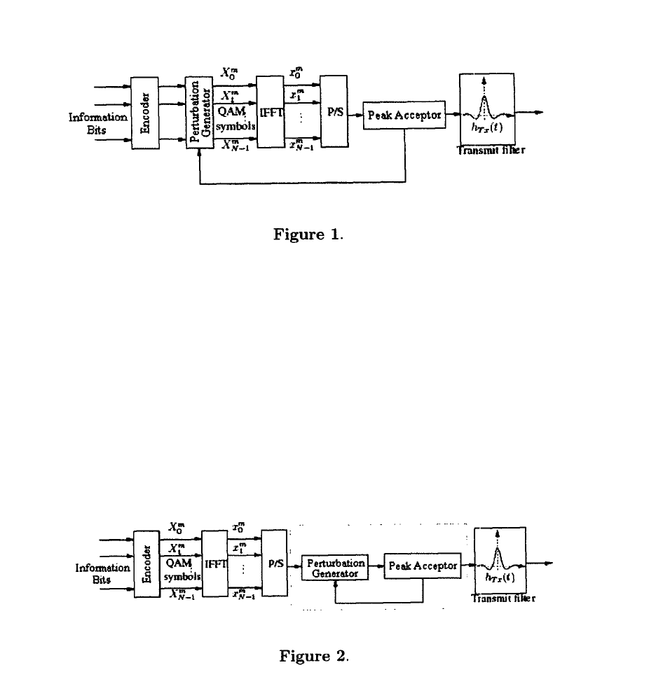

With reference to FIG. 1, there is shown an embodiment of the functional blocks of a multi-carrier system, for example an orthogonal frequency division multiplexing (OFDM) system. Included in the figure are the functional units for generating perturbations (errors) and for computing and deciding whether to accept the peak to average power ratio (PAPR) in the signal before it is allowed to be transmitted. FIG. 1 shows the iterative loop and the error insertion in the frequency domain for reference (see FIG. 2 and below for error insertion in the time domain). The perturbation generator inserts errors that are correctable by the existing error correction capability of the receiver. The exact components in the multi-carrier system can be any components known in the art that can permit the introduction of error for reducing PAPR using the methodology described herein.

An incoming stream of information to be transmitted is split into N sub-carriers and encoded from a finite set of symbols of size M. On the k-th sub-carrier, the symbols are selected from the set Xₖ^{m}ε{X₀^{m}, X₁^{m}, . . . , X_{N-1}^{m}}. The m-th OFDM symbol, which spans a time interval of [(m−1)T,mT], is constructed by

$${x}^{m} ( t ) = {\sum }_{k = 0}^{N - 1} {X}_{k}^{m} {e}^{j 2 π {kf}_{0} t} , \qquad ( 1 )$$

where f₀=1/T and j=\sqrt{−1}. Here the Xₖ^{m} are referred to as a modulation symbol. Sampling x^{m}(t) in eq. (1) at time intervals t=nT_{b} where T_{b}=T/N, we arrive at the discrete time version of an OFDM frame,

$${x}^{m} ( n ) = {\sum }_{k = 0}^{N - 1} {X}_{k}^{m} {e}^{j 2 π k \cdot n / N} , \qquad ( 2 )$$

where the OFDM symbol, x^{m}(n), is constructed from the modulation symbols, Xₖ^{m}, through an inverse discrete Fourier transform (IFFT in FIG. 1).

The PAPR of the signal, x^{m}(t), is given as the ratio of the peak instantaneous power to the average power, written as:

$$P A P R = {max}_{0 \leq t \leq T} \frac{{\vert {x}^{m} ( t ) \vert}^{2}}{E [ {\vert {x}^{m} ( t ) \vert}^{2} ]} \qquad ( 3 )$$

where E[•] is the expectation operator. As N increases the PAPR increases due to constructive interference. The PAPR of the continuous time signal, x^{m}(t), is well approximated from the sampled version of the OFDM symbol, x^{m}(n), provided that an up-sampling factor of at least 4 is used.

The modulation symbols encode the signal in digital form. The bit mapping of the signal can be performed in many ways. An example is quadrature amplitude modulation (QAM) which is used in the transmission of digital cable television. With a QAM encoding the signal in sub-carrier, k, at frequency, fₖ, will be encoded as

xₖ(t)=Iₖ cos(2πfₖt)+Qₖ sin(2πfₖt). (4)

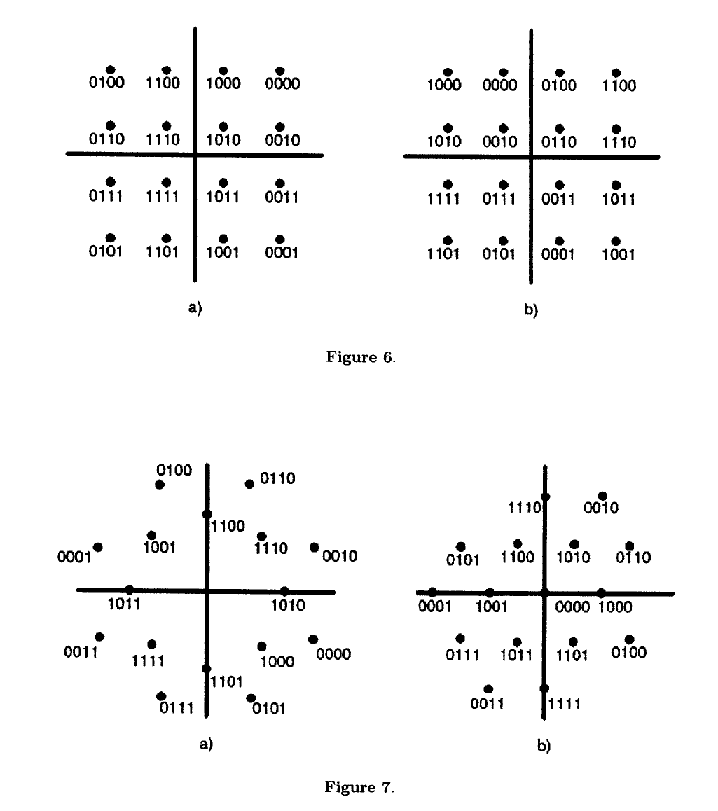

Here Iₖ and Qₖ are chosen from a discrete set of values which forms the set of modulation symbols. This symbol space can be represented in a constellation diagram which plots the allowed symbols on the I-Q plane. A bit mapping scheme further assigns hit patterns to each symbol point. The transmitter and receiver must use the same bit mapping scheme. The conventional scheme is Gray coding on a rectangular lattice as shown in FIG. 6(a). Other schemes and shapes are possible. The appropriate choice of scheme and shape significantly aids in PAPR reduction as discussed below.

In this invention the PAPR is reduced by changing the modulation symbol to a different symbol in such a way that the error correction capability of the receiver will recognize that the symbol has been changed and correct it returning the original symbol. It is this process by which correctable errors are inserted. This process is iterative; each symbol in each sub-carrier is considered for modification. The PAPR is computed and tracked to find the lowest value. Multiple passes of this algorithm may be performed to insert multiple errors in the data stream. The stream, including the set of errors introduced to reduce the PAPR, is then transmitted. The receiver corrects the errors using its existing error correction capability. If the full error correction capability of the receiver is employed for PAPR reduction and the complete space of error insertion is searched then the PAPR will be a minimum.

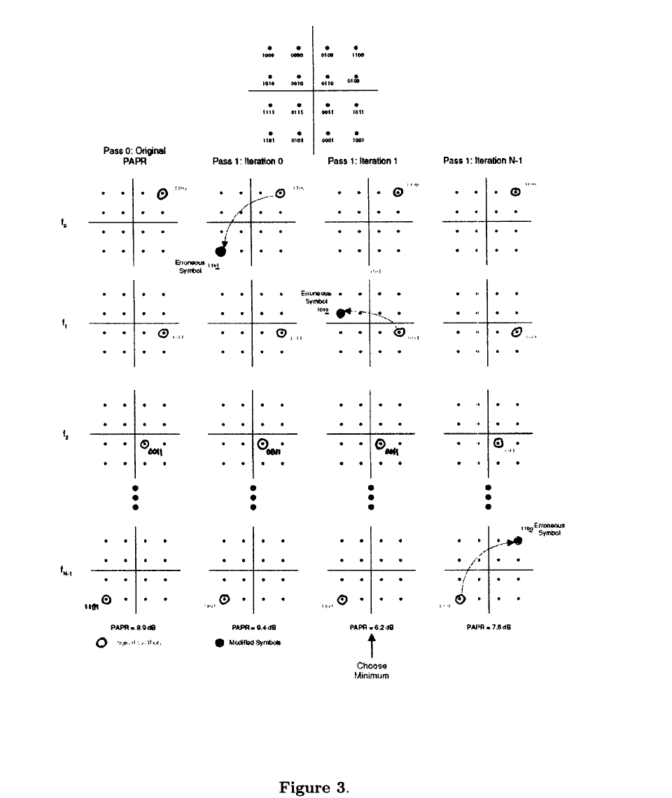

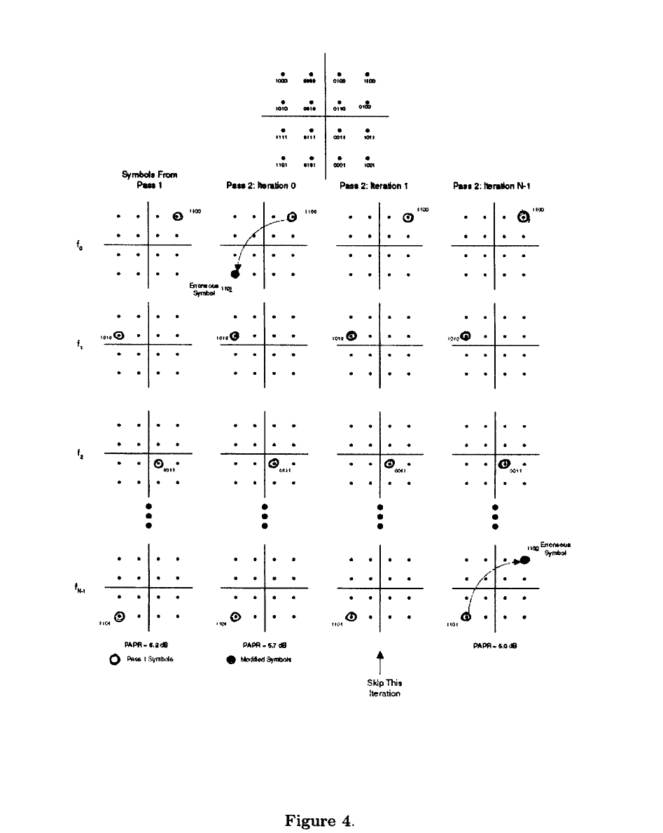

An example of the PAPR reduction iteration is shown in FIGS. 3 and 4. In this example a 16-ary symmetric code bit mapping scheme is employed as shown at the top of the figures. For simplicity of the presentation it is assumed the receiver can only correct errors in the last bit. Of course, this method can be used in receivers that correct errors in other bits. For N sub-carriers there are N iterations. As shown in FIG. 3 for an iteration, k, the error is inserted into sub-carrier k, the PAPR is computed and tracked. At the end of the iterations the minimum PAPR is noted and the error that produced it inserted into the stream. This defines a pass. If only 1 error is allowed then this signal would be sent to the receiver. If more errors are allowed then more passes are performed following the same procedure. The second pass is shown in FIG. 4. As seen in this figure, the sub-carrier(s) which already contain errors are not considered for further error insertion.

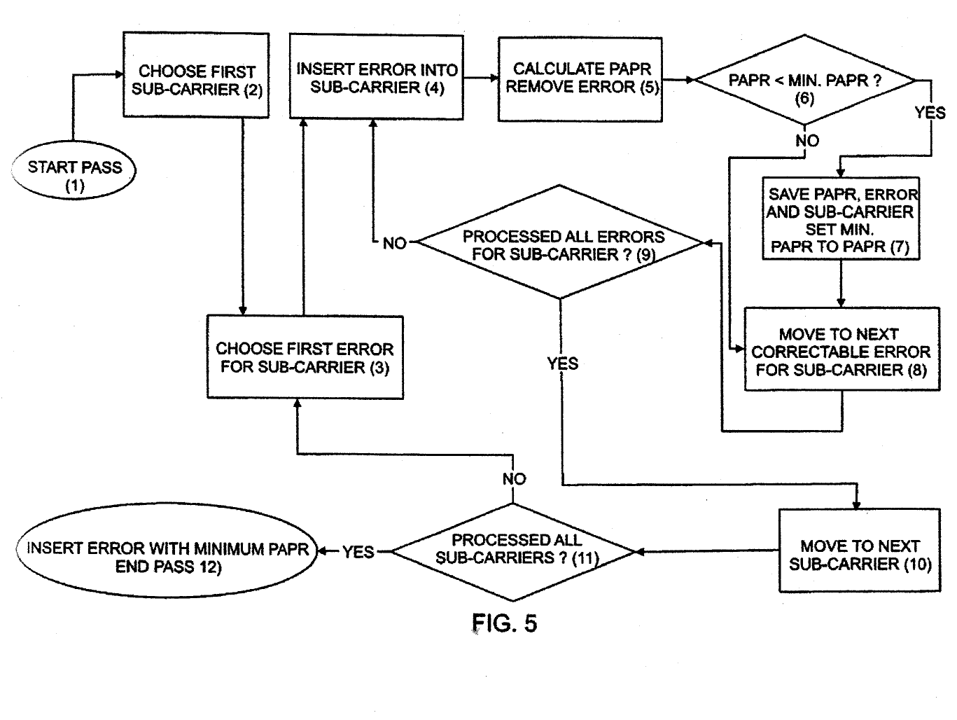

This simple example shows an implementation of the method using error insertion in the frequency domain and is well suited for OFDM systems. The method can be generalized beyond the simple example. Shown in FIG. 5 is a flowchart for a single pass of the algorithm. The pass begins by choosing the first sub-carrier in which to insert errors, step (2) in the figure. If previous passes have been performed this step will skip sub-carriers that already have had errors inserted. Next the first error to test is chosen from the set of errors correctable by the error correction capabilities of the receiver, step (3). This error is then inserted into the sub-carrier, step (4) and the PAPR is calculated according to eq. (3), step (5). The error is removed after the PAPR is calculated returning the stream to its original state for further testing. If the PAPR is less than the minimum PAPR the error and sub-carrier are saved for later use. The minimum PAPR is also set to the new minimum value, step (7). The next error in the set of correctable errors is considered, step (9). If there are more errors to consider in this iteration the error is inserted, step (4), and the iteration repeated. If not the next sub-carrier is considered, step (10). Again if this is part of a multi-pass system then sub-carriers with errors inserted on previous passes are skipped. If there are more sub-carriers to consider then the first correctable error is considered, step (3), and the iteration repeated. If all sub-carriers have been considered then the saved error that lead to the minimum PAPR is inserted into the saved sub-carrier, step (12). This sets the new signal and ends the pass. If this is the last pass then the signal is sent to the receiver, if not this signal is fed back in and a new pass is begun, step (1).

In the general algorithm outlined in FIG. 5 the complete set of correctable errors for each sub-carrier has been considered for each pass, thus the PAPR will be a minimum after each pass. The errors may be inserted in either the frequency or time domain. As shown in FIGS. 1 and 2 the only change is the location where the iteration takes place, the procedure remains the same.

The efficacy of the system is improved by using specialized, non-traditional bit mapping schemes, as a Gray mapping and is not optimal for PAPR reduction. Since a large PAPR is caused by constructive interference more significant PAPR reduction is gained by increasing the Euclidean distance between symbols that are correctable by the error correction capability of the receiver. One technique for generating non-traditional bit mapping schemes is by employing radial symmetry. FIG. 6 shows in (a) a traditional 16-ary Gray mapping and in (b) a proposed 16-ary mapping scheme using radial symmetry. Mapping scheme of other shapes can be designed using this symmetry. For example, shown in FIG. 7 are mapping schemes for (a) a circular distribution and (b) a hexagonal distribution. Schemes for other bit sizes and shapes can be generated and many are known in the art. The method of PAPR reduction does not depend on the bit mapping scheme employed, though the amount of PAPR reduction can depend on it. Both the transmitter and receiver must agree on the bit mapping scheme being employed.

This method builds on the increased computation power available in transmitters today. Even so, the full complexity of the method is not required to attain significant PAPR reduction. The complexity of the method can be reduced at the cost of a marginal decrease in the PAPR reduction capabilities of the system. The trade off between computation complexity and PAPR reduction is a major advantage of this method.

The performance of a PAPR reduction scheme can be quantified by the complementary cumulative distribution function (CCDF) which is independent of the amplifier that is used in the communication system. The CCDF is defined by

CCDF=Prob(PAPR[x(t)]>PAPRₜₕᵣₑₛₕ) (5)

Here PAPRₜₕᵣₑₛₕ is a threshold of interest. As a reference the CCDF value of 10⁻⁴ will be used to define the threshold. For this value of the threshold 99.99% of the time the PAPR of the signal x(t) will be lower than the threshold value.

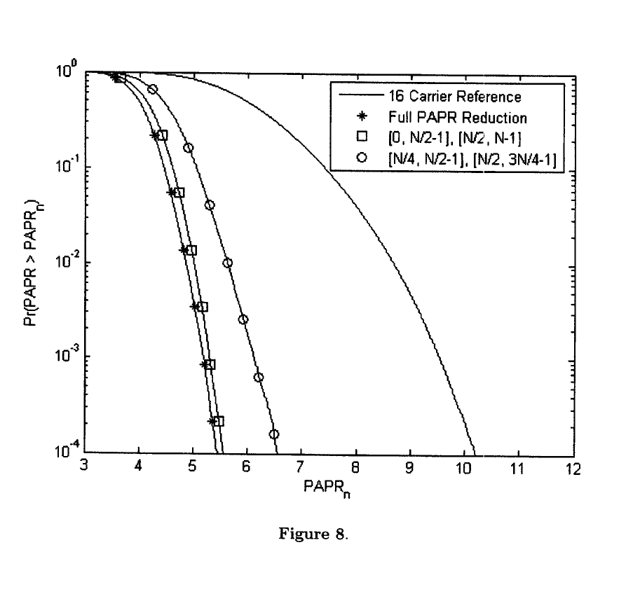

The full PAPR reduction calculation requires iterating over all the sub-carriers. As shown in FIG. 8 for a system based on an IDFT only half of the sub-carriers need to be searched. This reduces the computational complexity of the method by a factor of 2 with only a marginal decrease in the PAPR reduction capabilities.

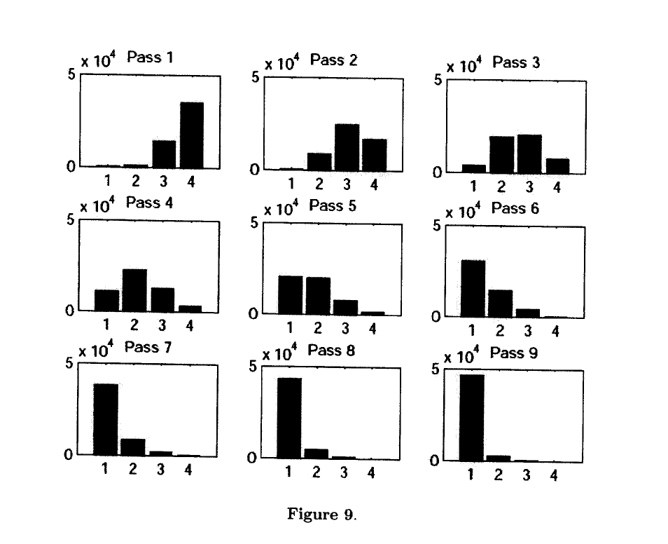

The full set of allowed errors does not need to be checked at every pass. FIG. 9 shows the frequency with which modulation symbols are changed in the 16-ary proposed mapping scheme (FIG. 6(b)) as a function of the pass of the method. In the figure “1” refers to no modulation symbol being changed (no inserted error led to significant PAPR reduction) and “2”, “3”, and “4” refer to the corresponding three amplitude levels in the mapping scheme with “4” being the outermost ring (points furthest from the center). As is seen in the figure for the early passes the outermost symbols are the most likely to lead to significant PAPR reduction. For subsequent passes symbols closer to the center become more likely. The exact procedure this implies will depend on the mapping scheme employed and the number of sub-carriers. This will lead to varying reductions in complexity of the method depending on the number of the pass.

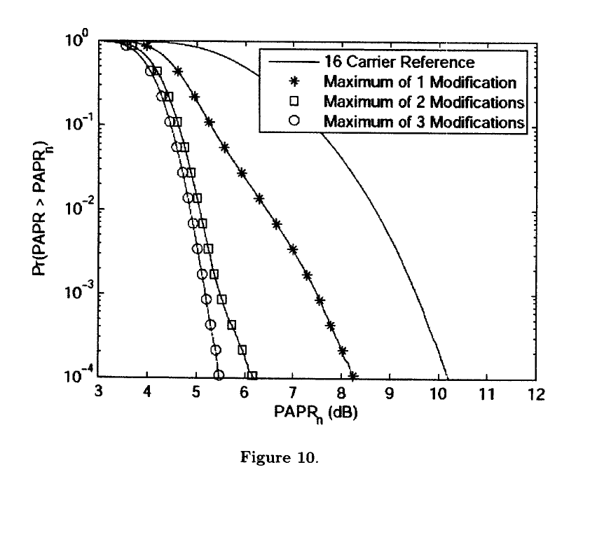

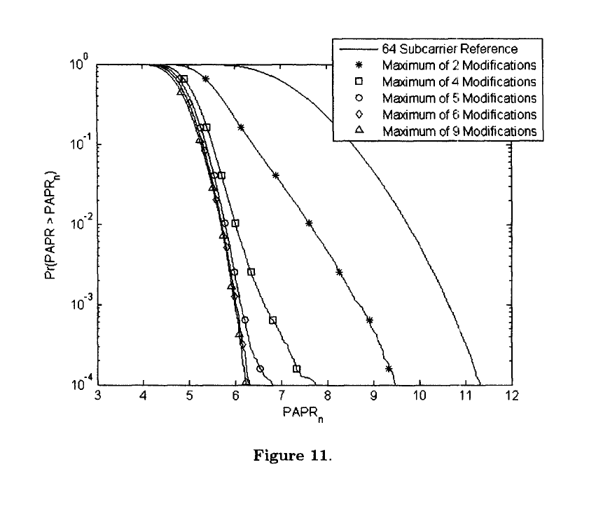

FIG. 9 also shows that subsequent passes lead to marginal reductions in the PAPR. This is further shown in FIG. 10 (for the same N=16 configuration) and in FIG. 11 for a N=64 configuration. It is seen that for N=64 allowing a maximum of 6 modifications (that is, a maximum of 6 errors to be inserted) gives nearly the minimum PAPR. Thus for this N=64 configuration there is little benefit in allowing more than 6 errors. This places an upper limit on the calculation complexity of the method.

The number of passes can be traded against the amount of PAPR reduction in a number of ways. As discussed above, studies can be performed on a system prior to deployment to determine the maximum number of errors worth attempting to introduce. This will set an upper limit on the complexity of the algorithm. Error insertion schemes can be tuned to only iterate over errors that are likely to lead to significant PAPR reduction. Additionally or alternatively the number of passes can be monitored dynamically in the transmitter. The iterative process can keep track of the PAPR reduction at each pass. When the change in PAPR between passes falls below some threshold the process can be terminated. If the linear range of the amplifier in the transmitter is know then the error insertion can be terminated when the PAPR falls in this linear range.

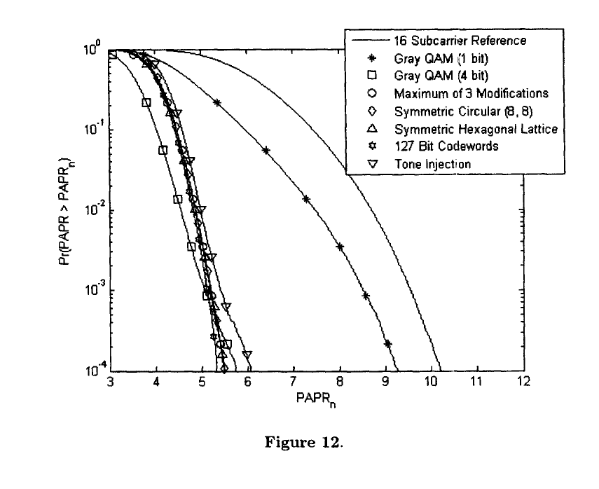

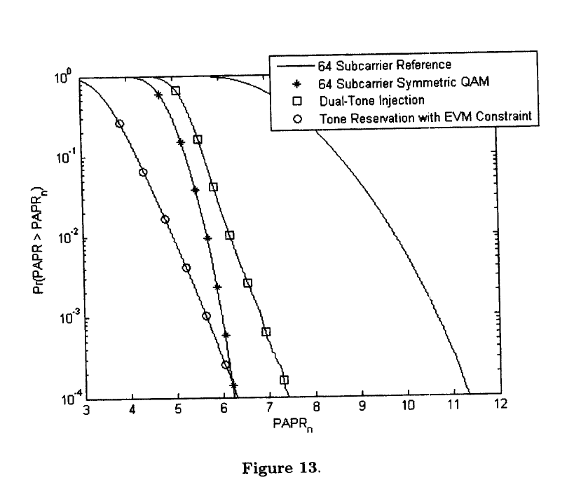

As shown in FIGS. 12 and 13 many alternative methods of PAPR reduction have been proposed. FIG. 12 shows the PAPR CCDF for a 16-ary, 16 sub-carrier signal while FIG. 13 shows the PAPR CCDF for a 16-ary, 64 sub-carrier signal. As shown in the figures all the symmetric bit mapping schemes considered above lead to comparable PAPR reduction. The Gray mapping scheme with only the last bit allowed to change, labeled (1 bit) in the figure, has poor PAPR reduction by comparison. The Gray mapping scheme with all the bits allowed to vary, labeled (4-bit) in the figure, has a PAPR reduction performance comparable to the symmetric mapping schemes but has four times the computational complexity. If the size of the codewords sent to and decoded by the receiver is increased then multiple symbols can be packed into one codeword. Though this introduces a delay in decoding the signal stream, since the receiver must wait until it receives the full codeword containing multiple symbols to begin the decoding, it allows for a larger error space for each symbol. For example, if a codeword can contain two symbols and the receiver can correct 1 bit of error per symbol, by putting two symbols in one word 2 bits of error can be inserted in one symbol and no error in the other symbol. This can lead to a larger PAPR reduction. In the case shown in the figure using 127 bit codewords leads to an improvement of order 0.5 dB over the symmetric bit mapping schemes with only 1 symbol per codeword. Tone injection and tone reservation will be discussed below. The PAPR reduction method presented in this patent provides PAPR reduction at least as good as existing schemes, while maintaining the flexibility of trading off PAPR, reduction for error correction and computational complexity.

The two alternative PAPR reduction schemes compared here are tone injection and tone reservation. In tone injection the symbol space is enlarged by introducing a correctable change to the modulation amplitude. A modulation symbol, X, is modified to be

\hat{X}=X+pD+jqD (6)

where p and q are integers and D is an arbitrary, positive real number. The original symbol, X, can be recovered in the receiver by first applying a modulo-D operation to the received signal, \hat{X}. This approach reduces the PAPR at the expense of increasing the average power of the signal. The size of the increase in average power is determined by how large the symbol space is made (the values of p, q, and D allowed).

In tone reservation some of the sub-carriers are reserved for PAPR reduction which are chosen to “balance” the data signal, thus reducing the PAPR. The symbols used for the data sub-carriers, Xₖε{X₀, X₁, . . . , X_{d-1}} and those used for PAPR reduction, \tilde{X}ₖε{\tilde{X}₀, \tilde{X}₁, . . . , \tilde{X}_{N-d-1}} lie in disjoint spaces so symbols do not get confused by the receiver. Efficient means exist for computing the PAPR reduction symbols by subjecting the signal stream to an error vector magnitude (EVM) constraint

$$\sqrt{\frac{1}{{P}_{0} d} {\sum }_{k = 0}^{d - 1} \vert {\tilde{X}}_{k} - {X}_{k} \vert} \leq E V {M}_{max} . \qquad ( 7 )$$

Here P₀ is the average power of the original constellation and EVMₘₐₓ is the maximum EVM constraint.

As discussed above, FIG. 12 shows the PAPR reduction in a 16-ary system with 16 sub-carriers. In this case tone injection reduces the PAPR to within about 0.5 dB of the method described in this invention. With 64 sub-carriers tone injection does not lead to as significant PAPR reduction, as shown in FIG. 13. Also shown in this figure is a tone reservation system that performs as well as the method of this invention at the 10⁻⁴ level.

Every scheme for PAPR reduction affects the signal and trades off the PAPR against other factors. An important measure of performance is the bit error rate (BER), the likelihood that error will occur in the signal due to noise in the system. The Gray mapping scheme (see FIG. 6(a), for example) has an average BER of 1 by construction. The symmetric bit mapping schemes will have slightly larger average BER than the Gray mapping scheme. For example, the 16-ary, rectangular, symmetric mapping scheme introduced above (see FIG. 6(b)) has an average BER of 1.17.

For tone injection the BER increases as the size of the symbol space increases. This increase can be alleviated by increasing the distance between the original constellation and redundant constellations in the symbol space. However, increasing the distance further increases the power of the signalling point. The trade off in a tone injection scheme is between the BER and increase in signal power. This places restrictions on the size of the symbol space and thus the amount of PAPR reduction, particularly as the number of sub-carriers increases.

In a tone reservation system the modification of the data sub-carriers, eq. (7), introduces an irreducible error flooring effect into the system. Thus, although the PAPR reduction is similar between the tone reservation system discussed above and the method in this invention (FIG. 13), the BER is improved by the method presented here. Furthermore the trade off between the number of correctable errors introduced for PAPR reduction and the number of correctable errors due to noise in the system can be balanced in a straight forward manner.

As discussed, the inventive method presented here applies correctable error insertion to reduce the PAPR of a system. The method can be improved by using a specialized bit mapping scheme. The amount of PAPR reduction can be traded against the complexity of the method and the BER of the signal.

Although the present invention has been explained in relation to a simplified system. It is to be understood that many other modifications and variations on the schemes presented here can be made without departing from the spirit and scope of the invention hereinafter claimed.

1. A method of reducing the peak-to-average-power ratio (PAPR) in a multi-carrier system, comprising: iteratively introducing errors into a signal; calculating the PAPR for each iteration; and determining the error that results in a reduced PAPR, wherein each error introduced into the signal is chosen so that each error is correctable by an error correction capabilities of a receiver.

2. The method of claim 1, wherein the multi-carrier system is an orthogonal frequency division multiplexing (OFDM) system.

3. The method of claim 1, wherein the iterations are conducted until the PAPR is minimized.

4. The method of claim 3, wherein the iterations are conducted until the PAPR is reduced to a user defined predetermined value.

5. The method of claim 4, wherein the error is introduced in a transmitter.

6. The method of claim 5, wherein the error is corrected in the receiver.

7. The method of claim 6, wherein the receiver uses an error correction code.

8. The method of claim 7, wherein the error correction code is a forward error correction (FEC) code.

9. The method of claim 8, wherein the method further comprises using a non-Gray coding bit mapping scheme.

10. The method of claim 9, wherein the non-Gray coding bit mapping scheme is radially symmetric.

11. The method of claim 10, wherein the errors are introduced in a time domain.

12. The method of claim 10, wherein the errors are introduced in a frequency domain.

13. The method of claim 12, wherein the errors are 1 bit errors.

14. The method of claim 13, wherein the step of iteratively introducing error corn prises introducing error in a subset of the sub-carriers.

15. The method of claim 14, wherein the step of iteratively introducing error com prises introducing error in N/2 sub-carriers.

16. The method of claim 13, wherein the step of iteratively introducing error com prises limiting the maximum number of errors allowed.

17. The method of claim 13, wherein the step of iteratively introducing error comprises limiting the maximum number of errors allowed based on the average improve ment in the PAPR determined by the relationship (PAPR(n)−PAPR(m))/PAPR(n), where n and m represent different passes of the PAPR reduction scheme.

18. An OFDM communication system comprising:
a transmitter; and
a receiver
wherein the transmitter is configured to iteratively introduce errors into an OFDM signal, calculate the PAPR for each iteration, and determine the error that results in a reduced PAPR, in which each error introduced into the signal is chosen so that each error is correctable by the error correction capabilities of the receiver.

19. The system of claim 18, wherein the transmitter is configured to iterate until the PAPR is minimized.

20. The system of claim 19, wherein the iterations are conducted until the PAPR is reduced to a user defined predetermined value.

21. The system of claim 20, wherein the receiver uses an error correction code.

22. The system of claim 21, wherein the error correction code is a forward error correction (FEC) code.

23. The system of claim 22, wherein the transmitter and receiver utilize a non-Gray coding bit mapping scheme to introduce error into the signal.

24. The system of claim 23, wherein the non-Gray coding bit mapping scheme is radially symmetric.

25. The system of claim 24, wherein the transmitter introduces 1 bit errors.

26. The system of claim 25, wherein the transmitter iteratively introduces error into a subset of sub-carriers of the signal.

27. The system of claim 26, wherein the transmitter iteratively introduces error by limiting the maximum number of errors allowed based on the average improvement in the PAPR determined by the relationship (PAPR(n)−PAPR(m))/PAPR(n), where n and m represent different passes of the PAPR reduction scheme.
